(19) United States
(12) Patent Application Publication
(10) Pub. No.: US 2003/0032736 A1
(43) Pub. Date: Feb. 13, 2003

(54) Acrylic adhesive compositions containing ketonyl (meth)acrylate

(76) Inventors: Brendan J. Kneafsey, Dublin (IE); Gerry Coughlan, Dublin (IE)

Correspondence Address: Loctite Corporation, 1001 Trout Brook Crossing, Rocky Hill, CT, 06067, US

(21) Appl. No.: 10/111,549

(22) PCT Filed: Dec. 22, 2000
(86) PCT No.: PCT/IE00/00168

(30) Foreign Application Priority Data
Jan. 11, 2000 (IE) 2000/0019

(51) Int. Cl. C08G 63/91

(52) U.S. Cl. 525/418

(57) ABSTRACT

Use of a ketonyl [meth]acrylate as a replacement for at least a substantial portion of the content of hydroxy (lower alkyl) methacrylate in a curable acrylic adhesive composition.

Suitably the ketonyl [meth]acrylate is of the formula:

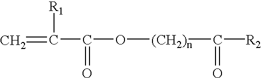

wherein: R₁ is H or C₁-C₅ alkyl, particularly C₁-C₂ alkyl;R₂ is C₁-C₅ alkyl, cyclohexyl, phenyl, benzyl, or substituted derivatives of any of the foregoing; and n is 1-5, for example acetonyl methacrylate.

### TECHNICAL FIELD

This invention relates to acrylic adhesive compositions and particularly to the use in acrylic adhesive formulations of monomers or reactive diluents which have not previously been reported as useful in adhesive compositions. The invention is applicable to acrylic adhesive compositions with any appropriate cure system. The adhesive compositions find use as bonding agents, sealants, gasketing materials and potting compositions, for example.

The term “adhesive composition” or “adhesive formulation” as used herein means a curable adhesive composition or formulation i.e. a composition or formulation which is curable when used as an adhesive. A curable adhesive composition is distinguished from a pressure sensitive adhesive which is already a product of polymerisation and which achieves adhesion (to the extent expected of a pressure sensitive adhesive) because it is inherently tacky, not because it is curable.

### BRIEF DESCRIPTION OF RELATED TECHNOLOGY

Numerous different acrylates and methacrylates are known as monomers in acrylic adhesive compositions. Frequently used monomers include hydroxy-containing [meth]acrylates, especially short-chain monoacrylate hydroxy (lower alkyl) methacrylates such as hydroxypropylmethacrylate (HPMA) and hydroxyethylmethacrylate (HEMA).

As used herein in relation to alkyl [meth]acrylates including hydroxyalkyl [meth]acrylates, the terms “short-chain” and “lower alkyl” mean having up to 5 carbon atoms in the alkyl group. More generally in relation to [meth]acrylate esters, the term “short chain” will be understood by those skilled in the art as meaning having up to 10 carbon atoms in the ester group, which may include one or more of ethers, ketones and other groups that do not interfere with the polymerisation.

Short-chain monofunctional [meth]acrylates may be used alone as monomers but are often used with polyfunctional [meth]acrylate monomers and/or with [meth]acrylate-terminated prepolymers or resins. In particular, short-chain [meth]acrylates are often added to acrylic adhesive compositions at the formulation stage, as a reactive diluent or short-chain monomer to be present in addition to a [meth]acrylate-terminated prepolymer or resin. Hydroxy (lower alkyl) [meth]acrylates are typically used for this purpose.

However there are commercial concerns with the ongoing use of hydroxy (lower alkyl) methacrylates such as HPMA and HEMA. That is, methacrylates of this type have recently come under scrutiny by regulatory authorities and there appears to be a trend towards seeking heightened labelling requirements for compositions containing these compounds. This regulatory issue is causing manufacturers of acrylic adhesives to search for alternatives to HPMA and HEMA with a view to replacing at least a substantial portion of the hydroxy (lower alkyl) [meth]acrylate content with other compounds which do not have the same perceived concerns. Accordingly, it would be desirable to provide alternative monoacrylate [meth]acrylates which can provide compositions having adhesive properties that are at least comparable to similar formulations containing HPMA and HEMA, and whose use is not clouded by the regulatory perception discussed above.

The use of ketonyl [meth]acrylates in acrylic adhesive compositions has not previously been suggested. U.S. Pat. No. 2, 376, 033 (Clifford) describes a method of producing keto esters of acrylic acids by reacting a metal salt of the acrylic acid with a halogen-substituted ketone. Compounds which may thus be prepared include acetyl methyl methacrylate (acetonyl methacrylate), alpha acetyl ethyl methacrylate, propionyl methyl methacrylate, cyclohexanonyl methacrylate, methyl cyclohexanonyl methacrylate, 1-carbethoxy acetyl methyl methacrylate, and benzoyl methyl methacrylate.

Goh et al. in Macromolecules (1991), 24(3), 806-8 describe the use of poly(acetonyl methacrylate) in blends containing an alpha methyl styrene/acrylonitrile copolymer. The poly(acetonyl methacrylate) was prepared by solution polymerization as described by Goh et al. in Polym. Bull. 1990, 23, 643 or by Chang et al. in Eur. Polym. J., 1990, 31, 1065. Ueda et al. in J. Polym. Sci., Part A: Polym. Chem (1988), 26(8), 2295-303 describe radical initiated homo-polymerization of acetonyl methacrylate and co-polymerization thereof with styrene, both with application of heat. The homopolymer is reported to be very soluble in various organic solvents. Chemical Abstracts reference 82 : 4613 reports a publication by Ito et al. in Nagova-Shi Kogyo Kenkvusho Kenkyu Hokoku (1974), (51), 29-33 which describes the synthesis and photo reaction of polyacyloin methacrylates. The activity of the polymers during the polymerization of methyl methacrylate is mentioned. However none of these publications describe the use of ketonyl methacrylates in adhesive compositions. Due to the lack of a hydroxy group, a ketonyl [meth]acrylate does not function as a cross-linking agent and therefore its performance in an adhesive composition could not be predicted.

International Patent Publication No. WO 96/18701 of Minnesota Mining and Manufacturing Company describes a removable pressure sensitive adhesive based on pressure sensitive adhesive microparticles that are the polymerization product of a mono-olefinically unsaturated monomer having an aldehyde group or a ketone group, and a base monomer. By the addition of a polyhydrazide, other adhesives which are described as having improved properties can be provided. it will be understood by those skilled in the art that a removable pressure sensitive adhesive comprising solid, inherently tacky microparticles of a polymerization product is different from a curable adhesive composition of the kind concerned in the present invention, which is used in liquid form and which is polymerized in the course of its use as an adhesive. The microparticles described in WO 96/18701 are prepared by methods which rely on aqueous suspension polymerization, usually requiring application of heat or radiation. The curable adhesive compositions of the kind concerned in the present invention are intended to polymerize when applied to a substrate by an end user, and suspension polymerization to form microparticles would not be appropriate for compositions of this kind. Polyhydrazides are not added to compositions of the kind concerned in the present invention and would not provide improved properties. WO 96/18701 belongs to a different field of adhesive technology and does not provide any teaching relevant to the present invention.

EP-A-O 134 490 of BASF AG describes a self-crosslinking coating or impregnating agent or adhesive which essentially consists of (A) copolymers of olefinically unsaturated monomers, which contain, as copolymerized units, from 0.0001 to 0.5 mole of alpha, beta-monoolefinically unsaturated aldehydes and/or ketones (a) per 10 g of copolymer, (B) reaction mixtures of from 0.001 to 2 equivalents, based on (a), of polyhydrazine compounds (b) with not less than 5 moles, per equivalent of (b), of monoaldehydes and/or monoketones (c) having boiling points of from 30 to 200 degrees C., and (C) from 0 to 900% by weight, based on the copolymer (A), of solvents which are inert to (b) and having boiling points of from 30 to 250 degrees C.

EP-A-O 134 490 is concerned with copolymerizate solutions which are used for the production of coatings of various kinds and impregnating agents. The solutions containing the copolymerizate and polyhydrazine reaction mixture are applied to a substrate and the solvent is evaporated off. This type of surface coating agent is also different from a curable adhesive composition which is polymerized in the course of its use. Although the composition of EP-A-O 134 490 is described as self-crosslinking, the olefinically unsaturated aldehyde or ketone has already been copolymerized in the preparation of the composition and is not present in the composition as a monomer or diluent. The composition requires the presence of a reaction mixture of a polyhydrazine compound with a monoldehyde and/or monoketone; polydrazine compounds themselves are not added to compositions of the kind concerned in the present invention.

Despite the state of the art, it would be desirable to provide acrylic adhesive compositions which display commercially acceptable cure properties and which on curing yield bonds with good durability in high humidity environments. In general, it would be desirable to provide acrylic adhesive compositions using monoacrylate [meth]acrylates which can replace (at least in part) HPMA and/or HEMA while maintaining good cure properties and bond characteristics.

### SUMMARY OF THE INVENTION

The present invention provides an adhesive formulation comprising:

(i) a polymerisable monoacrylate [meth]acrylate ester, at least a substantial portion of which is a ketonyl [meth]acrylate; optionally in combination with:

(ii) a polymerisable [meth]acrylic monomer; and

(iii) cure ingredients therefor.

Suitably, any polymerisable monoacrylate [meth]acrylate ester (i) present with the ketonyl [meth]acrylate is a short chain [meth]acrylate ester, including a short chain alkyl [meth]acrylate or hydroxyalkyl [meth]acrylate. Desirably the ketonyl [meth]acrylate is a short chain methacrylate ester.

In another aspect the invention provides an adhesive formulation comprising:

(a) a polymerisable [meth]acrylic monomer;

(b) a reactive diluent capable of co-polymerising with the said monomer, at least a substantial portion of which is a ketonyl [meth]acrylate; and

(c) cure ingredients for the monomer.

The term [meth]acrylate as used herein means acrylate or methacrylate. The formulation is curable in the course of use as an adhesive. The formulation in curable form is provided as an article of commerce for use as an adhesive, particularly a structural or mechanical adhesive, e.g. as a bonding agent, sealant, gasketing material or potting composition. The formulation generally does not contain any pressure sensitive adhesive microparticles. Generally no polyhydrazide or polyhydrazine reaction product is present or required. Generally no solvent is added other than the reactive diluent or polymerisable monoacrylate [meth]acrylate ester which can serve as a satisfactory solvent for the cure ingredients. It will be understood by those skilled in the art that normally the polymerisable ingredients are liquid and the curable adhesive formulation is liquid. The formulations of the present invention are generally curable without added energy such as heat.

It is an object of the present invention to reduce any content of free hydroxy (lower alkyl) methacrylate in the formulation to a level below that which would require labelling in a particular market. The term “a substantial portion” as used herein is to be interpreted in a manner consistent with this object. Suitably the term a “substantial portion” may indicate a proportion in the range from 10% to 100% by weight, desirably in the range from 40% to 100% by weight.

In the case where a ketonyl [meth]acrylate is used as a reactive diluent, the ketonyl [meth]acrylate desirably forms at least 80% by weight of the diluent, and more desirably 95-100% by weight of the diluent added to the monomer when making up the formulation.

Suitably, any remaining portion of the diluent is a conventional reactive diluent other than a monoacrylate hydroxy (lower alkyl) [meth]acrylate. Desirably the sole reactive diluent added to the monomer when making up the formulation is a ketonyl [meth]acrylate. Most desirably, any content of hydroxy (lower alkyl) methacrylate does not exceed 1% by weight of the total formulation.

The ketonyl [meth]acrylate not only acts as a reactive diluent but also serves as a satisfactory solvent for the cure ingredients and other additives (such for example as thickeners and stabilisers) in the formulation.

It has been found that adhesive compositions based on a ketonyl [meth]acrylate monomer have comparable adhesive properties and some improved humidity ageing characteristics as compared to similar adhesive compositions based on a conventional short-chain hydroxyalkyl [meth]acrylate monomer such as HPMA. No regulatory issues have arisen with regard to the ketonyl [meth]acrylates.

Suitably the ketonyl [meth]acrylate may be of the formula:

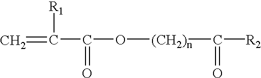

wherein:

R₁ is H or C₁-C₅ alkyl, particularly C₁-C₂ alkyl;

R₂ is C₁-C₅ alkyl, cyclohexyl, phenyl, benzyl, or substituted derivatives of any of the foregoing; and n is 1-5.

In the definition of R₂, “substituted derivatives” may be substituted or interrupted by oxygen, carbonyl or an ester group, particularly a C₁-C₅ alkyl ester group; or in the case of cyclohexyl, phenyl or benzyl, may be substituted with a C₁-C₅ alkyl group which may itself be optionally substituted or interrupted by oxygen, carbonyl or an ester group, particularly a C₁-C₅ alkyl ester group.

More suitably, n may be 1 or 2.

Most suitably, the ketonyl [meth]acrylate may be any of those described in U.S. Pat. No. 2, 376, 033 (Clifford) or GB-A-571,560 and listed in the acknowledgement of that document hereinabove. The contents of U.S. Pat. No. 2,376,033 (Clifford), including the preparation methods described therein, are incorporated herein by reference.

Suitably, the cure ingredients may provide any desired acrylic cure system, including free radical, anaerobic, photo-activated, air-activated, moisture-activated and any combination of these cure systems. A heat-activated cure system may also be used but, desirably, the cure system does not require the application of external heat.

The conventional ingredients for acrylic adhesive compositions are well known to those skilled in the art and are described, for example, in GB-A-1 422 439.

In a certain aspect, the present invention provides an anaerobic adhesive composition comprising:

(i) a polymerisable[meth]acrylic monomer selected from poly- and mono-functional [meth]acrylate esters and [meth]acrylate—terminated resins or prepolymers;

(ii) a reactive diluent capable of co-polymerising with the monomer, at least a substantial portion of the diluent being a ketonyl [meth]acrylate; and

(iii) ingredients for an anaerobic cure system for the monomer.

The invention further provides a method of bonding and/or sealing two substrates comprising applying an anaerobic adhesive composition as defined above to at least one substrate, and bringing the two substrates together so as to exclude oxygen from the composition, and allowing the composition to cure.

Anaerobic compositions generally contain an initiator such as peroxide, an accelerator such as an amine or organic sulfimide and a stabiliser.

In another aspect the invention provides a light-activated adhesive composition comprising:

(i) a polymerisable[meth]acrylic monomer selected from poly- and mono-functional [meth]acrylate esters and [meth]acrylate—terminated resins or prepolymers;

(ii) a reactive diluent capable of co-polymerising with the monomer, at least a substantial portion of the diluent being a ketonyl [meth]acrylate; and

(iii) ingredients for a light-activated cure system for the monomer.

The invention further provides a method of bonding and/or sealing two substrates comprising applying a light-activatable adhesive composition as defined above to at least one substrate, exposing the composition to light which activates the cure system, and bringing the two substrates together before or after the exposure to light.

Where the ketonyl [meth]acrylate is used with another [meth]acrylic monomer, the other [meth]acrylic monomer may be any of the monomeric or telechelic [meth]acrylates known in the field of adhesive and sealant compositions.

The other polymerizable [meth]acrylate ester monomers (i) suitable for use in this invention include a wide variety of materials such as those given in U.S. Pat. No. 3,218,305 (Krieble), U.S. Pat. No. 4,417,92 (Azevedo), U.S. Pat. No. 4,451,615 (Chamock), U.S. Pat. No. 5,116,558 (Wrobel et al.), and U.S. Pat. No. 3,996,308 (Douek et al.), the contents of which are incorporated herein by reference. One desirable class of polymerisable monomers is the poly- and mono-functional acrylate and methacrylate esters of the general formula:

CH₂═C(R)COOR¹ (I)

where R may be hydrogen, halogen or alkyl of 1 to about 4 carbon atoms, and R¹ may be selected from alkyl, cycloalkyl, alkenyl, cycloalkenyl, alkaryl, aralkyl or aryl groups of 1 to about 16 carbon atoms, any of which may be optionally substituted or interrupted as the case may be with silane, silicon, oxygen, halogen, carbonyl, hydroxyl, ester, carboxylic acid, urea, urethane, carbamate, amine, amide, sulfur, sulonate, sulfone and the like.

More specific acrylate monomers particularly desirable for use herein include polyethylene glycol di-[meth]acrylates, such as triethylene glycol di-methacrylate (“TRIEGMA”), dipropylene glycol di-[meth]acrylate, bisphenol-A di-[meth]acrylates, such as ethoxylated bisphenol-A methacrylate (“EBIPMA”) and tetrahydrofuran [meth]acrylates and di-[meth]acrylates, hexanediol di-[meth]acrylate, trimethylol propane tri-[meth]acrylate, methyl [meth]acrylate, cyclohexyl [meth]acrylate, 2-aminopropyl [meth]acrylate, an acrylate ester corresponding to the structure shown below:

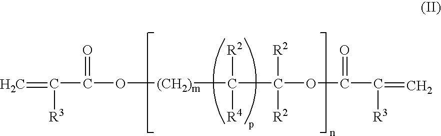

where R² may be selected from hydrogen, alkyl of 1 to about 4 carbon atoms, hydroxyalkyl of 1 to about 4 carbon atoms or

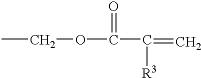

where R³ may be selected from hydrogen, halogen, and alkyl of 1 to about 4 carbon atoms;

R⁴ may be selected from hydrogen, hydroxy and

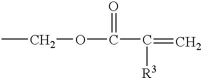

m is an integer equal to at least 1, e.g., from 1 to about 8 or higher, for instance, from 1 to about 4;

n is an integer equal to at least 1, e.g., 1 to about 20 or more; and

p is 0 or 1.

Of course, combinations of these [meth]acrylate monomers may also be used.

The [meth]acrylate monomers should desirably be present in the compositions within the range of from about 1% by weight to about 60% by weight, more desirably from about 5% by weight to about 50% by weight, such as from about 10% by weight to about 40% by weight, based on the total composition.

The polymerizable [meth]acrylate ester monomers suitably include a [meth]acrylate-terminated prepolymer in addition to a poly- or mono functional [meth]acrylate ester.

Other preferred acrylate ester monomers are urethane—acrylates as known to the art and disclosed, for example in U.S. Pat. No. 3,425,988 Gorman et al. or U.S. Pat. No. 4, 533, 446 Conway et al. the contents of which are incorporated herein by reference. Suitable monomers include those selected from the class consisting of urethane acrylates having the general formula:

(CH²═C(R⁵)COOR⁶OCONH—)₂R⁷ (III)

wherein R⁵ is H, CH₃, C₂H₅ or Cl; R⁶ is (i) a C₁₋₈ hydroxyalkylene or aminoalkylene group, (ii) a C₁₋₆ alkylamino C₁₋₈ alkylene, a hydroxyphenylene, aminophenylene, hydroxynaphthylene or aminonaphthylene optionally substituted by a C₁₋₃ alkyl, C₁₋₃ alkylamino or di-C₁₋₃ alkylamino group; and R⁷ is C₂₋₂₀ alkylene, alkenylene, or cycloalkylene, C₆₋₄₀ arylene, alkarylene, aralkylene, alkyloxyalkylene or aryloxyarylene optionally substituted by 1-4 halogen atoms or by 1-3 amino or mono- or di-C₁₋₃ alkylamino or C₁₋₃ alkoxy groups; or said acrylates having the general formula:

(CH₂═C(R⁵)COOR⁶OCON(H)R⁷N(H)COX—)ₙR⁸ (IV)

wherein R⁵, R⁶ and R⁷ have the meanings given above; R⁸ is the non-functional residue of a polyamine or a polyhydric alcohol having at least n primary or secondary amino or hydroxy groups respectively; X is O or NR⁹ where R⁹ is H or a C₁₋₇ alkyl group; and n is an integer from 2 to 20.

Copolymers or mixtures of monomers disclosed herein with other compatible monomers are also contemplated.

The anaerobic cure system useful in the present invention includes a variety of ingredients such as one or more initiators of polymerization and one or more accelerators of polymerization.

Initiators of free-radical polymerization useful in the instant composition include peroxides, hydroperoxides, peresters, and peracids. Desirably the initiator is a peroxide such as benzoyl peroxide or a hydroperoxide such as cumene hydroperoxide. Such initiators are generally present in the sealant composition in the amounts of about 0.1% to about 5% by weight of the composition, and desirably about 0.1% to about 2.0% by weight.

Commonly known accelerators of polymerization include amines (including amine oxides, sulfonamides, and triazines) and sulfimides. Tertiary amines, such as N,N-dimethyl-p-toluidine, N,N-dimethyl-o-toluidine, N,N-diethyl-p-toluidine and/or N,N-diethyl-o-toluidine, and sulfimides such as 3-oxo-2,3-dihydrobenz-[d]isothiazole-1,1-dioxide, commonly known as saccharin, are particularly useful as are acetyl phenylhydrazine and maleic acid. Two or more of these materials may be used in combination. Of course, other materials known to induce anaerobic cure may also be included or substituted therefor. See for example Loctite U.S. Pat. Nos. 3,218,305 (Krieble), 4,180,640 (Melody), 4,287,330 (Rich) and 4,321,349 (Rich). Other suitable accelerators are organometallic compounds, preferably organometallic polymers containing a metallocene moiety such as a ferrocene moiety. Suitable metallocenes in related compositions are disclosed more fully in U.S. Pat. No. 3,855,040. The accelerators are preferably added to the monomer in amounts of about 0.1% to about 2.5% by weight of the composition. Other metallo-containing materials which are non-polymeric have also been found to be effective.

Inhibitors and chelators, well recognised in the art for imparting stability to polymerizable compositions and for scavenging free radicals, are recommended. Those inhibitors useful in the present composition are usually selected from the group consisting of hydroquinones, benzoquinones, naphthoquinones, phenanthraquinones, anthraquinones, and substituted compounds of any of these. Naphthoquinone and anthraquinone are particularly suitable. Among the chelators which may be optionally present in the adhesive composition are the beta-diketones, ethylenediamine tetraacetic acid (EDTA) and the sodium salt of EDTA. Both the inhibitors and chelators may be effectively employed in levels of about 0.1 to about 1% by weight of the monomer, without adversely affecting the speed of cure of the polymerizable adhesive/sealant composition.

Photoinitiators enhance the rapidity of the curing process when photocurable compositions are exposed to electromagnetic radiation.

Such materials include, but are not limited to, photoinitiators available commercially from Ciba Specialty Chemicals, Tarrytown, N.Y. under the “IRGACURE” and “DAROCUR” tradenames, specifically “IRGACURT” 184 (1-hydroxycyclohexyl phenyl ketone), 907 (2-methyl-1-[4-(methylthio)phenyl]-2-morpholino propan-1-one), 369 (2-benzyl-2-nn N,N-dimethylamino-1-(4-morpholinophenyl)-1-butanone), 500 (the combination of 1-hydroxy cyclohexyl phenyl ketone and benzophenone), 651 (2,2-dimethoxy-2-phenyl acetophenone), 1700 (the combination of bis(2,6-dimethoxybenzoyl-2,4-,4-trimethyl pentyl phosphine oxide and 2-hydroxy-2-methyl-1-phenyl-propan-1-one), 819 (bis(2,4,6-trimethyl benzoyl) phenyl phosphine oxide) and “DAROCUR” 1173 (2-hydroxy-2-methyl-1-phenyl-1-propane) and 4265 (the combination of 2,4,6-trimethylbenzoyldiphenyl-phosphine oxide and 2-hydroxy 2-methyl-1-phenyl-propan-1-one); photoinitiators available commercially from Union Carbide Chemicals and Plastics Co. Inc., Danbury, Conn. under the “CYRACURE” tradename, such as “CYRACURE” UVI-6974 (mixed triaryl sulfonium hexafluoroantimonate salts) and UVI-6990 (mixed triaryl sulfonium hexafluorophosphate salts); and the visible light [blue] photoinitiators, dl-camphorquinone and “IRGACURE” 784DC. Of course, combinations of these materials may also be employed herein.

Photoinitiators particularly suitable for use herein include ultraviolet photoinitiators, such as 2,2-dimethoxy-2-phenyl acetophenone (e.g., “IRGACURE” 651), and 2-hydroxy-2-methyl-1-phenyl-1-propane (e.g., “DAROCUR” 1173) and the ultraviolet/visible photoinitiator combination of bis(2,6-dimethoxybenzoyl-2,4-,4-trimethylpentyl) phosphine oxide and 2-hydroxy-2-methyl-1-phenyl-propan-1-one (e.g., “IRGACURE” 1700), as well as the visible photoinitiator bis(h⁵-2,4-cyclopentadien-1-yl)-bis[2,6-difluoro-3-(1H-pyrrol-1-yl)phenyl]titanium e.g., “IRGACURE” 784DC).

According to another certain aspect, the present invention provides an air-activatable adhesive composition comprising:

a). at least one free-radically polymerisable monomer wherein all or a substantial part of the monomer content is a ketonyl [meth]acrylate, and

b). an activator system for effective polymerisation of the free-radically polymerisable monomer, said activator system comprising at least one auto-oxidisable compound,

with the proviso that the composition does not contain a peroxide, or a peroxide precursor which produces peroxide in the absence of air or any ingredient which is a significant source of radicals in the absence of air.

In the air-activatable composition as defined above, the presence of a weak acid is also generally preferred. The composition will also generally comprise one or more soluble ionic salts, particularly metal salts.

The auto-oxidisable compound may suitably be any of those described in EP-A-0,502,733 or EP-A-0,611,813 or their US equivalents, the contents of which are incorporated herein by reference. A particularly desirable auto-oxidisable compound is a dihydropyridine having a general formula selected from II:

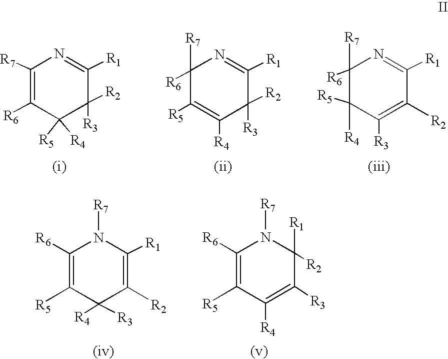

where: R₁ to R₇, which may be the same or different, are independently selected from hydrogen, hydrocarbyl and heterohydrocarbyl groups, silyl groups, and substituted derivatives of any of the foregoing, and any two of the groups R₁ to R₇ may together form a mono- or polycyclic ring structure, which may optionally be a fused ring structure, and which in turn may be substituted, provided that none of the groups R₁ to R₇ is a group which is known to interfere with polymerisation, and that in the case of 1,4-dihydropyridines of formula II (iv) the groups R₂ and R₅ at the 3- and 5-positions are not both electron-withdrawing groups.

For the auto-oxidisable compound (b), 1,4-dihydropyridines of formula II (iv) and 1,2-dihydropyridines of formula II (v) are preferred, the 1,2-dihydropyridines being most preferred. R₇ in the compounds of formula II (iv) or 11 (v) is preferably other than hydrogen, and more preferably is an electron-donating group. In the case of 1,4-dihydropyridines of formula II (iv) the groups R₂ and R₅ at the 3- and 5-positions must not both be electron-withdrawing groups such as ester, acid, ketone, amide or nitrile groups because such substituents would render the 1,4-dihydropyridine stable to air oxidation. Other 1,4-dihydropyridines including the parent 1,4-dihydropyridine react rapidly in air [N. C. Cook and E. J. Lyons, J. Amer. Chem. Soc., 87, 3238 (1965)].

The term “hydrocarbyl” as used herein includes:

(i) straight chain or branched linear or alicyclic aliphatic groups including alkyl, alkenyl and alkynyl, preferably containing from 1 to 20, more preferably from 1 to 10, most preferably from 1 to 5 carbon atoms; and alkylene and alkenylene groups forming part of a ring structure and which preferably contains from 3 to 30, more preferably 5 to 20 carbon atoms;

(ii) aromatic groups including aryl, alkaryl and aralkyl groups, preferably containing 6 to 20 carbon atoms, more preferably 6 to 10 carbon atoms, and optionally having a fused ring structure.

The term “heterohydrocarbyl” as used herein includes hydrocarbyl groups as described above interrupted by one or more hetero atoms selected from oxygen, nitrogen or sulphur.

The term “substituted” or “substituted derivative” as used herein includes the appropriate group substituted with one or more oxygen, nitrogen, sulphur or halogen atoms or atom-containing moieties, or with one or more hydrocarbyl, heterohydrocarbyl or silyl groups, which in turn may be substituted with one or more oxygen, nitrogen, sulphur or halogen atoms or atom-containing moieties. Preferably R₁ to R₇ and/or the substituents on the ring formed by any two of the R₁ to R₇ groups are hydrogen or methyl, ethyl, propyl, butyl, phenyl, benzyl, amide or trimethyl silyl groups. Halogen may be chlorine, bromine, fluorine or iodine.

Another group of autoxes having the structure I in EP-A-0,502,733 includes partially reduced diazines, more particularly dihydropyridazines, dihydropyrimidines and dihydropyrazines.

Other auto-oxidisable compounds which may be used include those described in EP-A-0,356,875, German Specification Nos. 3,829,461, 4,123,194 and 4,330,354 and the compounds described in our Irish patent application no. 980775 and International patent Publication No. WO 00/17241 entitled AUTO-OXIDATION SYSTEMS FOR AIR-ACTIVATABLE POLYMERISABLE, the contents of which, and of its U.S. equivalent, are incorporated herein by reference.

Preferred soluble ionic salts for inclusion in the air-activatable adhesive composition are metal salts of the type generally used in oil drying technology. The metals should have several valency states and suitable metal salts are those of multivalent metals, especially transition metals. The metal ions are preferably present in their low valency state. The metal salt must be at least partially soluble in the composition, and may be present in the composition in an effective amount which is generally in a range of between about 1 and about 1,000 parts per million, particularly about 1 to 300 ppm, more particularly about 30 to 200 ppm.

The choice of metal may have a velocity determining effect on initiation of polymerisation because of a temperature dependence of the metal component in the process. Iron, cobalt, manganese and vanadium are highly active at room temperature. In addition, compounds of these metals can be mixed with one or more other metallic components such as lead, cerium, copper, calcium, barium, zinc and/or zirconium.

Metal naphthenates or metal acetyl acetonates are generally soluble in the composition, but other salts or organometallics may be used if they are sufficiently soluble.

If the ketonyl [meth]acrylate is used in an air-activatable system with another free-radically polymerisable monomer, the second monomer may be selected from olefinically unsaturated systems such as acrylates, methacrylates, styrene, maleate esters, fumarate esters, unsaturated polyester resins, alkyd resins, thiol-ene compositions, and acrylate, methacrylate, or vinyl terminated resins including silicones and urethanes. Suitable acrylates and methacrylates are those used in polymerisable systems such as disclosed in U.S. Pat. No. 4,963,220 (Bachmann et al.), and U.S. Pat. No. 4,215,209 (Ray-Chaudhuri et al.). Other suitable monomers are methylmethacrylate, polyfunctional methacrylates, silicone diacrylates and polyfunctional acrylated urethanes of the type known to be useful in formulating adhesives [e.g. as disclosed in U.S. Pat. No. 4,092,376 (Douek et al.)] or a thiol-ene (e.g. as disclosed in U.S. Pat. Nos. 3,661,744, 3,898,349, 4,008,341 or 4,808,638).

The auto-oxidisable compound will generally be present in an effective amount for effecting polymerisation of the composition upon exposure to atmospheric oxygen. Such effective amount is generally within the range of from about 0.1 to about 20%, suitably from about 0.1 to about 10%, more suitably about 0.5 to about 5%, based on the weight of the polymerisable composition.

The weak acid, when required for the air-activatable adhesive composition, is an acid other than a mineral acid. The pKa of the weak acid normally is no lower than about 0.5 with the preferred limit being about 0.9. The upper limit is approximately 13, more desirably 11.5. However, carboxylic acids which have a pKa of up to about 8, desirably 6 or 7 are particularly suitable.

The carboxylic acids may contain one or more carboxyl groups, suitably 1 to 4 and more particularly 1 or 2 carboxyl groups. Suitable aliphatic carboxylic acids are C₁₋₁₈ and desirably C₁₋₁₀ monocarboxylic acids.

The choice of the acid depends to a large extent on the auto-oxidisable material being used. Suitable acids may be monobasic or polybasic. Typical but not limiting examples of suitable acids are formic acid, acetic acid, propionic acid, maleic acid, malic acid, fumaric acid, acrylic acid and copolymers thereof, methacrylic acid and copolymers thereof, pyruvic acid, itatonic acid, nadic acid, benzoic acid, phthalic acids, cinnamic acid, trichloroacetic acid and saccharin. The effective amount of the acid is generally within the range from about 0.1 to about 20%, suitably from about 0.1 to about 10%, more desirably from about 05 to about 5% based on the weight of the polymerisable composition.

A masked carboxylic acid compound hydrolyzable on contact with moisture, such as an acid anhydride, may be used. Attention is directed to EP-A-0 356 875 or its U.S. equivalent, the contents of which are incorporated herein by reference.

Peroxides, or peroxide percursors which produce peroxide in the absence of air, or any ingredient which is a significant source of radicals in the absence of air, should not be included in the air-activatable compositions, so that polymerisation of the free-radically polymerisable monomer does not commence until it is exposed to oxygen.

The air-activatable compositions of the present invention may suitably comprise 0.1 to 20% by weight of the auto-oxidisable compound, 0.1% to 20% by weight of the weak acid (if present) and at least 10% by weight of the free-radically polymerisable monomer, optionally with the ionic salt, thickeners, fillers, pigments, reducing agents and/or stabilisers, the total constituents adding up to 100%.

The invention also provides a method of bonding two substrates comprising applying an air-activatable adhesive composition as defined above to at least one substrate, exposing the composition to oxygen for sufficient time to activate polymerization, and bringing the two substrates together. Typically at least about 1 minute, but desirably at least about 2 minutes exposure to air would be suitable.

Furthermore, the invention provides a method of forming a polymer, for example in topical coatings, encapsulation, moulding and the like, comprising exposing to oxygen for sufficient time to activate polymerization a composition as defined above. Typically at least about 1 minute, but desirably at least about 2 minutes exposure to air would be suitable.

The above-described air-activatable compositions are stable when prepared in the absence of air. Exposure to air results in the polymerisation of the composition, the polymerisation being sustained in the presence or absence of air once the initial exposure to air has taken place. Typically, the exposure to air should be for at least about 5 seconds, preferably not less than 30 seconds, more preferably 1 to 5 minutes.

The air-activatable composition may be agitated during its exposure to oxygen to accelerate activation by introducing oxygen into the composition. The purpose of agitation is to increase the surface area of the composition exposed to the oxygen. For example, the composition may be applied to a substrate in finely divided form e.g. by spraying or in the form of a foam. The composition may be packaged in and/or dispensed from a container having a nozzle which entrains air as the composition is dispensed e.g. an aerosol container or pump-action aspirator. In addition, or alternatively, the composition may be agitated on the substrate e.g. by stirring. Agitation of the composition also improves cure-through-volume (CTV) in a layer having significant depth.

The invention further provides an air-activatable composition as described above packaged in an aerosol container or pump-action aspirator. General When any of the compositions of the invention are prepared with reactive diluents which are capable of copolymerising with the monomer(s), the concentration of such diluents should preferably be less than 60%, for example 40 to 10%, by weight of the composition.

The balance of the composition comprises the monomer together with other additives known to the art which may be employed as needed and at concentrations known in the art. One or more stabilisers, including polymerisation inhibitors such as those of the quinone or hydroquinone type and/or chelating agents, may suitably be used. Inhibitors are used in an amount sufficient to prevent premature polymerisation of the composition.

The composition may optionally further comprise reducing agents, thickeners, fillers and pigments.

Suitable reducing agents may be, but are not limited to, acetylphenylhydrazine, tetramethylthiourea or thiocaprolactam.

Polymeric thickeners may be present in the compositions in a minor amount, up to about 50%, and may be thickeners such as a polymer or prepolymer of low or high molecular weight. Suitable polymeric thickeners are a commercially available methacrylate polymer sold by E.I. du Pont de Nemours and Company, under the trademark Elvacite or by Rohm and Haas under the Trade Mark Ryloid, as well as styrene-methyl methacrylate co-polymers and polybisphenol A maleate (sold by ICI Americas Inc. under the trademark Atlac). It is also possible to add inert filling materials such as finely divided silica, fumed silica (treated or untreated), montmorillonite, clay, bentonite and the like. The use of micronized silica would result in a paste-like thixotropic composition.

Additionally, it is conventional to include in adhesive formulations certain “inert” fillers such as wood flour, glass fibres, cotton linters, mica, alumina, silica and the like to modify viscosity, improve impact resistance and for other purposes. Such fillers could be incorporated in the formulations of the present invention. Small percentages of silane monomers could also be added to increase moisture resistance, as well as to enhance bonding of an adhesive to glass and similar surfaces. Other substances such as dyes, fire retarders, stabilizers such as quinones and hydroquinones, thixotropes, plasticizers, antioxidants, and the like may also be included, although such additives may often be furnished in the principal ingredients, making their separate introduction unnecessary. A primer of a kind known in the art may be used on one or both surfaces, if desired. A copper based primer is preferred.

The invention is illustrated further in the following non-limiting examples. Example 1 describes anaerobic adhesive formulations having acetonyl methacrylate as a reactive diluent. Examples 2-5 describe air-activated compositions which illustrate one aspect of the invention but also show more generally that satisfactory adhesive properties are retained, and in some respects enhanced, when hydroxypropyl methacrylate is replaced wholly or partially by acetonyl methacrylate in an adhesive composition. Acetonyl methacrylate was prepared following the method described in U.S. Pat. No. 2,376,033 (Clifford).

### EXAMPLES

### Example 1

Acetonyl methacrylate was employed as a replacement for HPMA as the reactive diluent in a conventional peroxide-initiated anaerobic acrylic adhesive formulation, and tested under a variety of conditions. The monomer was a polyurethane methacrylate resin as used in conventional formulations and as described for example in U.S. Pat. No. 4,018,851. It should be noted that such resins may contain a small residue of HPMA which is in excess of the amount which was required for capping the polyurethane backbone. Such residual HPMA was not replaced by acetonyl methacrylate. However the content of residual HPMA in the resin can be monitored so that it does not exceed a certain percentage by weight (e.g. 1% by weight) of the total formulation.

Two formulations were made up as follows:

| | Formulation A | | Formulation B | |
|---|---|---|---|---|
| Polyurethane methacrylate resin | 73.7 | g | 73.7 | g |
| Hydroxypropyl methacrylate (Diluent) | 14.5 | g | — | |
| Acetonyl methacrylate (Diluent) | — | | 14.5 | g |
| Acrylic acid | 6.0 | g | 6.0 | g |
| Saccharin | 1.0 | g | 1.0 | g |
| Cumene hydroperoxide | 2.0 | g | 2.0 | g |
| Other ingredients (accelerator, | 3.0 | g | 3.0 | g |
| stabiliser, chelating agent, dye) | | | | |

Each formulation was tested as an anaerobic adhesive and also as a primer-activated adhesive, using conventional testing procedures well known to those skilled in the art.

The test results are presented in the following table, in which the following abbreviations are used:

RT=room temperature: Min=minutes: h=hours

Primer N is a copper-containing primer which is commercially available from Loctite Corporation:

| | | Bond Strength (MPa) | |
|---|---|---|---|
| Test | Conditions | A | B |
| Compressive Shear | RT Cure, 15 Min. | 12 | 10 |
| (Degreased | RT Cure 24 h | 14 | 17 |
| Pins/Collars) | | | |
| Tensile Shear | RT 18 h | 11 | 10 |
| (Degreased Mild Steel | RT 18 h, Primer N | 5 | 4.6 |
| Laps) | on one side | | |
| | RT 18 h, Primer N | 5 | 5.2 |
| | on two sides | | |
| Compressive Shear | RT 13 days | 25 | 29 |
| (Degreased | RT 22 days | 27 | 29 |
| Pins/Collars) | 50:50 Water/Glycol | 30 | 27 |
| | 13 days at 87° C. | | |
| | 50:50 Water/Glycol | 26 | 30 |
| | 22 days at 87° C. | | |
| Tensile Shear | RT 22 days | 23 | 26 |
| (Degreased Mild Steel | 50:50 Water/Glycol | 9 | 13 |
| Laps) | 13 days at 87° C. | | |
| | 50:50 Water/Glycol | 4 | 11 |
| | 22 days at 87° C. | | |

The table above shows that formulation B containing acetonyl methacrylate showed similar room temperature performance and “durability” to formulation A and an overall superior humidity ageing performance in a water/glycol mixture at elevated temperature.

Light-activated acrylic adhesive formulations are also made up in which acetonyl methacrylate is used as the reactive diluent in place of HPMA and the monomer and other ingredients are conventional, as known to the person skilled in the art. Radiation activatable anaerobic adhesive formulations are prepared by mixing the following ingredients together in the following weight percentages:

| | C | D |
|---|---|---|
| Monomer A | 23.3 | 23.3 |
| Monomer B | 50.7 | 50.7 |
| Hydroxypropyl methacrylate | 20.5 | — |
| Acetonyl methacrylate | — | 20.5 |
| Diphenyliodonium | 2.87 | 2.87 |
| hexafluorophosphate | | |
| Ferrocene | 0.944 | 0.944 |
| Cumene hydroperoxide | 1.64 | 1.64 |

Monomer A is a urethane-acrylate reaction product of toluene diisocyanate and the hydroxypolyoxypropylene derivative of trimethylolpropane (commercially available under the trademark Pluracol TP 2450) having unreacted isocyanate functionality capped with hydroxyethl methacrylate.

Monomer B is urethane-acrylate prepared by reacting two moles of toluene diisocyanate with 1 mole of hydrogenated bisphenol A, diluting the reaction mixture with methyl methacrylate and further reacting it with two moles of hydroxyethyl methacrylate in the manner disclosed in Example V of U.S. Pat. No. 3,425,988.

Pairs of mild steel grit blasted lapshears, 2 centimeters wide are coated on one face with the adhesive composition C and D and irradiated at 700 μW/cm² (measured at 365 nm) for a time interval which is different for each of seven groups of pairs. The coated surfaces of each pair are firmly placed in contact 45 seconds after cessation of irradiation, to give in each case a half inch overlap in the length direction of the lapshears for an adhesive bond to develop. The bonds are left for 24 hours at room temperature to cure. The bond strengths are measured in the tensile shear mode, using conventional tensile testing equipment. The results for Formulation C are quoted in U.S. Pat. No. 4,533,446 (Conway et al.). Based on the results in the examples of this application, it is expected that comparable bond strengths are obtained for Formulation D.

### Example 2

An air-activatable adhesive composition comprising:

| | | |
|---|---|---|
| acetonyl methacrylate | 4.25 | g |
| methacrylic acid | 0.25 | g |
| 0.1% Ferric acetylacetonate in | 0.25 | g |
| hydroxypropyl methacrylate | | |
| N-phenyl-2 propyl-3, 5-diethyl-1, | 0.25 | g |
| 2-dihydropyridine | | |

was prepared under anaerobic conditions and activated in air for 2 and 4 minutes giving bond strengths of 20 MPa on mild steel test specimens after 24 hours. Identical bond assemblies aged at 87° C. in water/glycol for 7 days gave bond strengths of 7-10 MPa. Similarly prepared formulations, having hydroxypropyl methacrylate (HPMA) as the monomer, gave zero strengths following ageing under these same conditions.

### Example 3

An adhesive formulation (A) was prepared by formulating in the proportions outlined in the table below, acetonyl methacrylate, methacrylic acid and Fe(III) acetylacetonate. This formulation was then added to a 25 ml aluminium tube and exposed to a steady stream of inert gas such as nitrogen through a syringe needle for at least two minutes. N-phenyl-2 propyl-3,5-diethyl-1,2-dihydropyridine was added to the formulation under the inert atmosphere. The aluminium tube was then sealed by crimping, thus trapping inert gas in the head space above the formulation. The aluminium tube was shaken for 10-20 seconds to ensure thorough mixing of the formulation components. A similar formulation (B) was prepared comprising hydroxypropyl methacrylate. The compositions of the formulations are as follows:

| | Formulation A | | Formulation B | |
|---|---|---|---|---|
| Acetonyl methacrylate | 8.5 | g | — | |
| Hydroxypropyl methacrylate | — | | 8.5 | g |
| Methacrylic acid | 0.5 | g | 0.5 | g |
| 0.1% Fe(III) Acetylacetonate | 0.5 | g | 0.5 | g |
| oil in Hydroxypropyl methacrylate | | | | |
| N-phenyl-2 propyl-3,5-diethyl-1,2- | 0.5 | g | 0.5 | g |
| dihydropyridine | | | | |

The adhesive compositions were tested as follows; samples of the adhesive were squeezed from the aluminium tube and spread onto mild steel test-pieces (100×25 mm-4×1 inches) to form a film of approximately 0.1 mm in depth and exposed to air for a measured interval (hereafter referred to as the open time). Following the open time the mild steel test-pieces were brought together to form an adhesive joint with 12.5 mm-0.5 inch overlap. The bond strengths for bonds assembled using the above procedure and allowed to cure for 24 hours were tested according to ASTM—D1002 and are presented in the table below.

| | Formulation (A) | Formulation (B) |
|---|---|---|
| Open Times/ | Shear Strengths | Shear Strengths |
| Minutes | MPa | MPa |
| 2 | 21 | 14 |
| 4 | 20.3 | 14 |

Similar sets of bond assemblies were aged in 50:50 water/glycol solutions at 87° C. for seven days, removed, and allowed to cool and tested to give the following results.

| | Formulation (A) | Formulation (B) |
|---|---|---|
| Open Times/ | Shear Strengths | Shear Strengths |
| Minutes | MPa | MPa |
| 2 | 7 | 0 |
| 4 | 7 | 0 |

The assemblies prepared from formulation (B) had lost all bond strengths.

### Example 4.

Adhesive compositions comprising the components outlined in the following table were prepared using the procedures outlined in the previous example.

| | Formulation | |
|---|---|---|
| Acetonyl methacrylate | 23 | g |
| Hydroxypropyl methacrylate | 20 | g |
| 30% polymethyl methacrylate in methyl | 42 | g |
| methacrylate | | |
| Methacrylic acid | 5 | g |
| 0.1% Fe(III) acetylacetonate oil in | 5 | g |
| hydroxypropyl methacrylate | | |
| N-phenyl-2 propyl-3,5-diethyl-1,2- | 5 | g |
| dihydropyridine | | |

The adhesive formulation was tested as in the previous example giving the following results:

| | Formulation |
|---|---|
| Open Times/ | Shear Strengths |
| Minutes | MPa |
| 2 | 18 |
| 4 | 19 |

Similar tests on polyvinyl chloride test pieces gave the following results:

| | Formulation |
|---|---|
| Open Times/ | Shear Strengths |
| Minutes | MPa |
| 2 | 2 |
| 4 | 1.8 |

### Example 5

Adhesive compositions comprising the components outlined in the following table were prepared using the procedures outlined in the previous examples.

| | Formulation A | |
|---|---|---|
| Acetonyl methacrylate | 42.5 | g |
| 30% polymethyl methacrylate in methyl | 42.5 | g |
| methacrylate | | |
| Methacrylic acid | 5 | g |
| 0.1% Fe(III) acetylacetonate oil in | 5 | g |
| hydroxypropyl methacrylate | | |
| N-phenyl-2 propyl-3,5-diethyl-1,2- | 5 | g |
| dihydropyridine | | |

The adhesive formulation was tested as in the previous examples giving the following results with mild steel substrates:

| | Formulation |
|---|---|
| Open Times/ | Shear Strengths |
| Minutes | MPa |
| 2 | 20 |
| 4 | 21 |

Similar sets of bond assemblies were aged in 50:50 water/glycol solutions at 87° C. for 96 hours, removed, and allowed to cool and tested to give the following results.

| | Formulation |
|---|---|
| Open Times/ | Shear Strengths |
| Minutes | MPa |
| 2 | 10 |
| 4 | 8 |

Similar tests on polyvinyl chloride test pieces gave the following results:

| | Formulation |
|---|---|
| Open Times/ | Shear Strengths |
| Minutes | MPa |
| 2 | 2 |
| 4 | 2.3 |

The words “comprises/comprising” and the words “having/including” when used herein with reference to the present invention are used to specify the presence of stated features, integers, steps or components but do not preclude the presence or addition of other features, integers, steps, components, or groups thereof.

Although some embodiments of the invention have been described above, many modifications and equivalents thereof will be clear to those of ordinary skill in the art and are intended to be covered hereby, the true spirit and scope of the invention being defined by the claims.

1. An adhesive formulation comprising:
(I) a polymerisable monoacrylate [meth]acrylate ester, at least a substantial portion of which is a ketonyl [meth]acrylate, optionally in combination with:
(ii) a polymerisable [meth]acrylic monomer; and
(iii) cure ingredients therefor.

2. An adhesive formulation comprising:
(a) a polymerisable [meth]acrylic monomer;
(b) a reactive diluent capable of co-polymerising with the said monomer, at least a substantial portion of the diluent being a ketonyl [meth]acrylate; and
(c) cure ingredients for the monomer.

3. A formulation according to claim 1 or 2 wherein the substantial portion is a proportion in the range from 10 to 100% weight.

4. A formulation according to claim 3 wherein the substantial portion is a proportion in the range from 40% to 100% by weight.

5. A formulation according to claim 2 wherein the ketonyl [meth]acrylate forms at least 80% by weight of the reactive diluent.

6. A formulation according to claim 5 wherein the ketonyl [meth]acrylate forms 95-100% by weight of the diluent.

7. A formulation according to claims 2, 5 or 6 wherein any remaining portion of the diluent is a conventional diluent other than a hydroxy (lower alkyl) [meth]acrylate.

8. A formulation according to any of claims 2 or 5-7 wherein the sole reactive diluent which has been added to the monomer when making up the formulation is a ketonyl [meth]acrylate.

9. A formulation according to any of the preceding claims wherein any content of free hydroxy (lower alkyl) methacrylate does not exceed 1% by weight of the total formulation.

10. A formulation according to any of claims 2 to 9 which is an anaerobic adhesive composition wherein at least part of the monomer content comprises a [meth]acrylate-terminated resin or prepolymer.

11. A formulation according to any of the preceding claims wherein the ketonyl [meth]acrylate is of the formula: 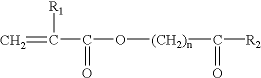
wherein: R₁ is H or C₁-C₅ alkyl, particularly C₁-C₂ alkyl;R₂ is C₁-C₅ alkyl, cyclohexyl, phenyl, benzyl, or substituted derivatives of any of the foregoing; and n is 1-5.

12. A formulation according to claim 11 wherein R₁ and R₂ are both C₁-C₂ alkyl.

13. A formulation according to claim 12 wherein the ketonyl [meth]acrylate is acetonyl methacrylate.

14. Use of a ketonyl [meth]acrylate as a replacement for at least a substantial portion of the content of hydroxy (lower alkyl) methacrylate in an acrylic adhesive composition.

15. Use according to claim 14 wherein a proportion in the range from 10% to 100% by weight of the content of hydroxy (lower alkyl) methacrylate is replaced.

16. Use according to claim 15 wherein a proportion in the range from 40% to 100% by weight is replaced.

17. Use according to any of claims 14-16 wherein any remaining content of free hydroxy (lower alkyl) methacrylate does not exceed 1% by weight of the total composition.

18. Use according to claims 14-17 wherein the ketonyl [meth]acrylate is as defined in any of claims 11-13.

19. A method of preparing an acrylic adhesive composition which conventionally would contain a hydroxy (lower alkyl) methacrylate, wherein at least a substantial portion of the hydroxy (lower alkyl) methacrylate content is replaced by a ketonyl [meth]acrylate.

20. A method according to claim 19 wherein a proportion in the range from 10% to 100% by weight of the content of hydroxy (lower alkyl) methacrylate is replaced.

21. A method according to claim 20 wherein a proportion in the range from 40% to 100% by weight is replaced.

22. A method according to any of claims 19-21 wherein any remaining content of free hydroxy (lower alkyl) methacrylate does not exceed 1% by weight of the total composition.

23. A method according to claims 19-22 wherein the ketonyl [meth]acrylate is as defined in any of claims 11-13.

24. A method of bonding and/or sealing two substrates comprising applying an adhesive formulation according to any of claims 1 to 13 to at least one substrate, bringing the two substrates together, and allowing the composition to cure.

25. Substrates bonded by use of a formulation according to any of claims 1 to 13 and/or by a method according to any of claims 19-23.
